(19) United States
(12) Patent Application Publication
(10) Pub. No.: US 2025/0148770 A1
(43) Pub. Date: May 8, 2025

(54) APPARATUS FOR GENERATING TRAINING DATA, A LEARNING METHOD FOR A TARGET NETWORK FOR GENERATING TRAINING DATA, AND A METHOD FOR GENERATING TRAINING DATA USING THE TARGET NETWORK

(71) Applicants: HYUNDAI MOTOR COMPANY, Seoul (KR); KIA CORPORATION, Seoul (KR)

(72) Inventors: Jae Hoon Cho, Seoul (KR); Jae Hyeon Park, Seoul (KR); Hyun Kook Park, Seoul (KR)

(73) Assignees: HYUNDAI MOTOR COMPANY, Seoul (KR); KIA CORPORATION, Seoul (KR)

(21) Appl. No.: 18/771,235

(22) Filed: Jul. 12, 2024

(30) Foreign Application Priority Data
Nov. 6, 2023 (KR) 10-2023-0151996

(51) Int. Cl. G06V 10/82; G06V 10/80

(52) U.S. Cl. CPC G06V 10/82; G06V 10/80

(57) ABSTRACT

A training data generation apparatus may include a first network and a second network that individually learn a first image based on supervised learning and perform ensemble learning on a second image based on unsupervised learning. The apparatus also may include a fusion network that obtains a fusion output value based on the ensemble learning results of the first network and the second network. The apparatus also may include a target network that learns the second image to imitate the fusion output value.

### CROSS-REFERENCE TO RELATED APPLICATION

This application claims the benefit of priority to Korean Patent Application No. 10-2023-0151996, filed in the Korean Intellectual Property Office on Nov. 6, 2023, the entire contents of which are incorporated herein by reference.

### TECHNICAL FIELD

The present disclosure relates to a training data generation apparatus, a learning method of a target network for generating training data, and a method of generating training data by using a target network. More specifically, the present disclosure relates to a technology for generating training data of a multi-task learning network.

### BACKGROUND

Devices utilizing artificial intelligence are increasingly used, and thus research on a deep learning technology is actively being conducted. For example, deep learning networks may perform tasks, such as detecting objects from an image, classifying classes and estimating depth values by recognizing the image.

Deep learning generally processes one task among various tasks. However, multi-task learning, which learns two or more tasks simultaneously, has emerged.

The multi-task learning is a method of simultaneously learning multiple tasks by using a plurality of output layers in one deep learning network. While making a network lightweight, the multi-task learning may process a variety of tasks, by learning the plurality of tasks by using one backbone.

To learn a multi-task learning network, there is a need for a training data set to which ground-truth data is matched for each task. Collecting a training data set to which ground-truth data is matched requires a lot of time and money. Moreover, when a new task is added in a multi-task learning network, a task of labeling of input data for learning the added task needs to be accompanied. The subject matter described as background technology above is only to aid in understanding the background of the present disclosure. The above subject matter should not be taken as acknowledgment that it corresponds to prior art already known to those having ordinary skill in the art.

### SUMMARY

The present disclosure has been made to solve the above-mentioned problems occurring in the prior art while advantages achieved by the prior art are maintained intact.

Aspects of the present disclosure provide a training data generation apparatus capable of easily obtaining a training data set having matched ground-truth data, a learning method of a target network for generating training data, and a method of generating training data by using the target network.

Aspects of the present disclosure provide a training data generation apparatus capable of easily obtaining a training data set having matched ground-truth data without requiring an additional labeling task on input data, a learning method of a target network for generating training data, and a method of generating training data by using the target network.

The technical problems to be solved by the present disclosure are not limited to the aforementioned problems. Any other technical problems not mentioned herein should be more clearly understood from the following description by those having ordinary skill in the art to which the present disclosure pertains.

According to an aspect of the present disclosure, a training data generation apparatus may include a first network and a second network that individually learn a first image based on supervised learning and perform ensemble learning on a second image based on unsupervised learning. The training data generation apparatus may also include a fusion network that obtains a fusion output value based on ensemble learning results of the first network and the second network. The training data generation apparatus may also include a target network that learns the second image to imitate the fusion output value.

According to an embodiment, the target network may learn the first image based on the supervised learning and then may learn the second image to imitate the fusion output value.

According to an embodiment, each of the first network, the second network, and the target network may learn the first image based on the supervised learning in a state where initial values of a first parameter of the first network, a second parameter of the second network, and a third parameter of the target network are different from each other.

According to an embodiment, each of the first network and the second network may adjust a second parameter of the second network by performing ensemble learning on the first network and the second network, with a first parameter fixed. Each of the first network and the second network may also adjust the first parameter of the first network by performing ensemble learning on the first network and the second network, with a second parameter fixed.

According to an embodiment, the second network may adjust the second parameter to reduce a deviation between a 1-1st output value obtained by the first network learning the second image to which a first augmentation technique is applied and a 2-2nd output value obtained by the second network learning the second image to which a second augmentation technique is applied. The first network may adjust the first parameter to reduce a deviation between a 1-2nd output value obtained by the first network learning the second image to which the second augmentation technique is applied and a 2-1st output value obtained by the second network learning the second image to which the first augmentation technique is applied.

According to an embodiment, the second network may adjust the second parameter by using a first loss function obtained based on the 2-2nd output value and a first correction output. The first correction output is obtained by augmenting the 1-1st output value with the second augmentation technique. Moreover, the first network may adjust the first parameter by using a second loss function obtained based on the 1-2nd output value and a second correction output. The second correction output is obtained by augmenting the 2-1st output value with the second augmentation technique.

According to an embodiment, the fusion network may output the fusion output value of one channel based on a first input value obtained by concatenating the first correction output and the 2-2nd output value and based on a second input value obtained by concatenating the second correction output and the 1-2 output value.

According to an embodiment, the target network may obtain a third output value output by the target network by learning the second image and may perform learning to reduce a deviation in a third loss function obtained based on the third output value and the fusion output value.

According to an embodiment, the target network may obtain pseudo label data by learning the second image to imitate the fusion output value and then learning an image without a ground-truth label.

According to an embodiment, each of the first network, the second network, and the target network may be implemented based on a multi-task learning network for obtaining output values for two or more different tasks.

According to an aspect of the present disclosure, a learning method of a target network for generating training data may include individually learning, by a first network, a second network, and a target network, a first image based on supervised learning. The learning method may also include performing, by the first network and the second network, ensemble learning on a second image. The learning method may also include obtaining, by a fusion network, a fusion output value based on ensemble learning results of the first network and the second network. The learning method may also include learning, by the target network, the second image to imitate the fusion output value.

According to an embodiment, performing, by the first network and the second network, the ensemble learning on the second image may include performing unsupervised learning by using the second image without ground-truth data.

According to an embodiment, individually learning the first image based on the supervised learning may include performing learning in a state where initial values of a first parameter of the first network, a second parameter of the second network, and a third parameter of the target network are different from each other.

According to an embodiment, performing, by the first network and the second network, the ensemble learning on the second image may include adjusting a second parameter of the second network by performing ensemble learning on the first network and the second network, with a first parameter fixed. Performing the ensemble learning on the second image may also include adjusting the first parameter of the first network by performing ensemble learning on the first network and the second network, with a second parameter fixed.

According to an embodiment, adjusting the second parameter of the second network may include obtaining, by the first network, a 1-1st output value by learning the second image to which a first augmentation technique is applied. Adjusting the second parameter may include obtaining, by the second network, a 2-2nd output value by learning the second image to which a second augmentation technique is applied. Adjusting the second parameter may include adjusting the second parameter to reduce a deviation between the 1-1st output value and the 2-2nd output value. Adjusting the first parameter of the first network may include obtaining, by the first network, a 1-2nd output value by learning the second image to which the second augmentation technique is applied. Adjusting the first parameter may include obtaining, by the second network, a 2-1st output value by learning the second image to which the first augmentation technique is applied. Adjusting the first parameter may include adjusting the first parameter to reduce a deviation between the 1-2nd output value and the 2-1st output value.

According to an embodiment, adjusting the second parameter may include using a first loss function obtained based on the 2-2nd output value and a first correction output, which is obtained by augmenting the 1-1st output value with the second augmentation technique. Adjusting the first parameter may include using a second loss function obtained based on the 1-2nd output value and a second correction output, which is obtained by augmenting the 2-1st output value with the second augmentation technique.

According to an embodiment, obtaining, by the fusion network, the fusion output value based on the ensemble learning results of the first network and the second network may include generating a first input value by concatenating the first correction output and the 2-2nd output value. Obtaining the fusion output value may also include generating a second input value by concatenating the second correction output and the 1-2 output value. Obtaining the fusion output value may also include outputting, by the fusion network, the fusion output value of one channel based on the first input value and the second input value.

According to an embodiment, learning, by the target network, the second image to imitate the fusion output value may include generating, by the target network, a third output value by learning the second image. Learning the second image to imitate the fusion output value may include performing, by the target network, learning to reduce a level of a third loss function obtained based on the third output value and the fusion output value.

According to an embodiment, generating, by the target network, the third output value by learning the second image may include learning the second image to which the second augmentation technique is applied.

According to an aspect of the present disclosure, a method for generating training data may include individually learning, by a first network, a second network, and a target network, a first image based on supervised learning. The method for generating training data may also include performing, by the first network and the second network, ensemble learning on a second image based on unsupervised learning. The method for generating training data may also include obtaining, by a fusion network, a fusion output value based on the ensemble learning results of the first network and the second network. The method for generating training data may also include performing, by the target network, learning such that the result of learning the second image imitates the fusion output value. The method for generating training data may also include obtaining pseudo label data by learning an image without a ground-truth label based on the target network.

### BRIEF DESCRIPTION OF THE DRAWINGS

The above and other objects, features, and advantages of the present disclosure should be more apparent from the following detailed description taken in conjunction with the accompanying drawings:

FIG. 1 is a diagram showing a structure of a target network for generating training data, according to an embodiment of the present disclosure;

FIG. 2 is a diagram for describing training data generated according to an embodiment of the present disclosure;

FIG. 3 is a flowchart for describing a method of learning a target network, according to an embodiment of the present disclosure;

FIG. 4 is a diagram for describing supervised learning of a first network, a second network, and a target network;

FIGS. 5A and 5B are diagrams for describing ensemble learning of a first network, a second network, and a target network;

FIG. 6 is a diagram for describing a method in which a fusion network generates a fusion output;

FIG. 7 is a diagram for describing a method of learning a target network based on a fusion output;

FIGS. 8A, 8B, and 8C are diagrams for describing training data generated by a target network, according to an embodiment of the present disclosure; and

FIG. 9 is a block diagram illustrating a computing system according to an embodiment of the present disclosure.

### DETAILED DESCRIPTION

Hereinafter, some embodiments of the present disclosure are described in detail with reference to the accompanying drawings. In adding reference numerals to components of each drawing, it should be noted that the same or equivalent components include the same reference numerals, although the components are indicated on another drawing. Furthermore, in describing the embodiments of the present disclosure, detailed descriptions associated with well-known functions or configurations have been omitted where the detailed descriptions may make subject matter of the present disclosure unnecessarily obscure.

In describing elements of an embodiment of the present disclosure, the terms first, second, A, B, (a), (b), and the like may be used herein. These terms are only used to distinguish one element from another element but do not limit the corresponding elements irrespective of the nature, order, or priority of the corresponding elements. Furthermore, unless otherwise defined, all terms including technical and scientific terms used herein should be interpreted as is customary in the art to which the present disclosure belongs. It should be understood that terms used herein should be interpreted as including a meaning that is consistent with their meanings in the context of the present disclosure and the relevant art and should not be interpreted in an idealized or overly formal sense unless expressly so defined herein.

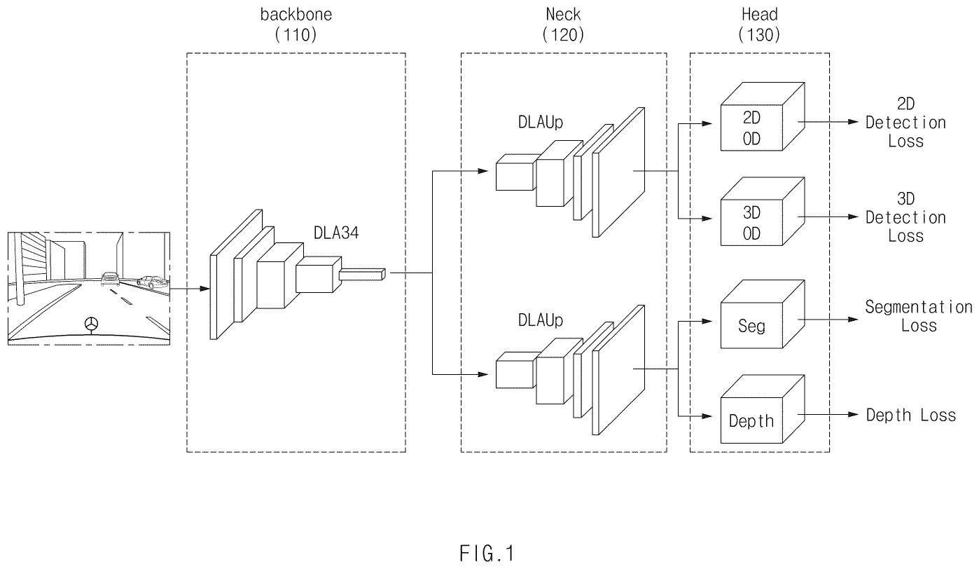

Hereinafter, various embodiments of the present disclosure are described in detail with reference to FIGS. 1-9.

FIG. 1 is a diagram showing a structure of a target network for generating training data, according to an embodiment of the present disclosure.

Referring to FIG. 1, a target network according to an embodiment of the present disclosure may be a deep learning network capable of performing multi-task learning. The target network may process two or more tasks by performing image learning. For example, the target network may perform 2D object detection, 3D object detection, semantic segmentation, and depth value estimation.

To this end, the target network may include a backbone 110, a neck 120, and a head 130.

The backbone 110 may be feature extractors including one or more layers and may output a feature map. The backbone 110 may be a shared structure in a process of performing different tasks.

The neck 120 may be a structure for connecting the backbone and the head.

The head 130 may be a structure identified to perform each task and may, for example, include heads corresponding to the number of tasks processed by the target network. The head 130 may output a loss function (2D Detection Loss) for 2D object detection and a loss function (3D Detection Loss) for 3D object detection. Moreover, the head 130 may output a loss function (segmentation loss) for semantic segmentation and a loss function (depth loss) for depth value estimation.

The target network according to an embodiment of the present disclosure may generate training data for multi-task learning.

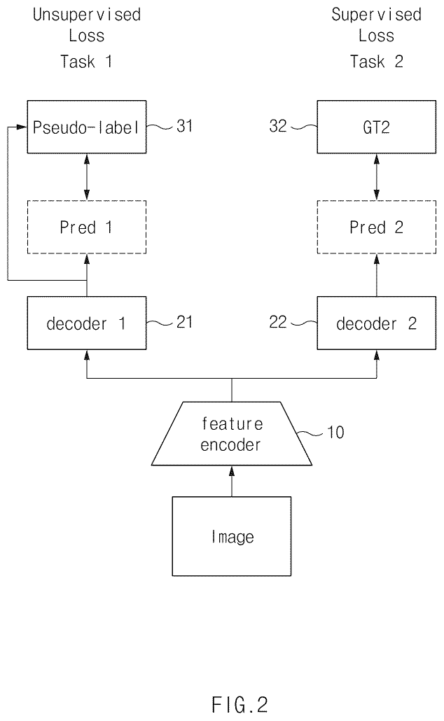

The training data generated by the target network according to an embodiment of the present disclosure may be pseudo label data and may be used in a learning process of another multi-task learning. This is described with reference to FIG. 2 as follows.

FIG. 2 is a diagram for describing training data generated according to an embodiment of the present disclosure.

Referring to FIG. 2, a training data generated by a target network according to an embodiment of the present disclosure may be used as pseudo labeling data 31 of a multi-task learning network.

The multi-task learning network for image learning may include one encoder 10 and two or more decoders 21 and 22.

The encoder 10 may be a backbone to extract image features.

Each of the first decoder 21 and the second decoder 22 may generate an output for processing different tasks. The multi-task learning network may simultaneously process two or more related tasks. However, to this end, there is a need for ground-truth labeling corresponding to each task.

When there is ground-truth data 32 for a second task processed by the second decoder 22, the second decoder 22 may perform learning based on the ground-truth data 32.

When there is no ground-truth data for a first task, the recognition performance for the first task may deteriorate or learning may be difficult. According to an embodiment of the present disclosure, tasks without ground-truth data may be processed by using the pseudo labeling data 31 generated by using the target network.

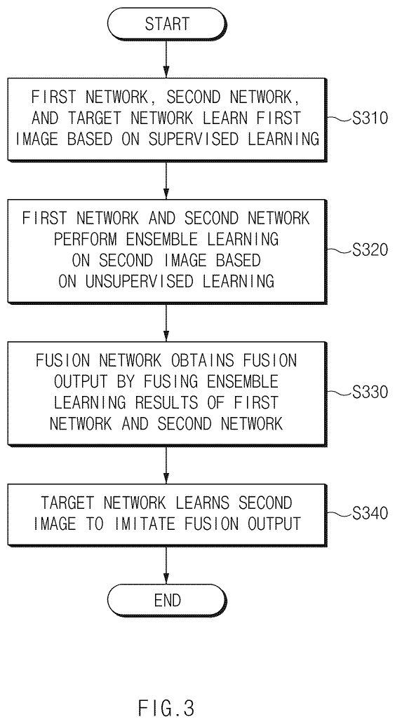

FIG. 3 is a flowchart for describing a method of learning a target network, according to an embodiment of the present disclosure. With reference to FIGS. 1 and 3, a method of learning a target network according to an embodiment of the present disclosure is as follows.

The target network may be a network for multi-task learning. A backbone, a neck, and a head of the target network may use the structure shown in FIG., but may not be limited thereto.

In S310, each of a first network, a second network, and a target network may individually learn a first image based on supervised learning.

Like the target network, the first network and the second network may be networks for multi-task learning. Backbones of the first network, the second network, and the target network may have the same structure as each other or may use backbones of different structures from each other. The first network may perform learning by using a first parameter that is a parameter. As in the above description, the second network may perform learning by using a second parameter, and the target network may perform learning by using a third parameter.

The first image may be an image with ground-truth data (GT label). In other words, the first network may learn a first image based on supervised learning; the second network may learn the first image based on supervised learning; and the target network may learn the first image based on supervised learning.

In S320, the first network and the second network may perform ensemble learning on a second image.

The first network may perform ensemble learning with the second network while the second parameter of the second network is fixed.

The second network may perform ensemble learning with the first network while the first parameter of the first network is fixed.

In S330, the fusion network may obtain a fusion output value based on the ensemble learning results of the first network and the second network.

The fusion network may generate a fusion output value including advantages of the first network and the second network by integrating the ensemble learning results of the first network and the second network.

In S340, the target network may learn the second image to imitate the fusion output value.

The target network may generate a third output value by learning the second image and may perform learning by using a third loss function obtained based on the third output value and the fusion output value. For example, the target network may perform learning to reduce the level of the third loss function.

Through S340, the target network may learn the second image while imitating advantages of the first network and the second network. Therefore, even when the target network learns a second image without a ground truth (GT) label, the target network may obtain an output value close to ground-truth data.

Hereinafter, each of procedures described in FIG. 3 is described in more detail as follows.

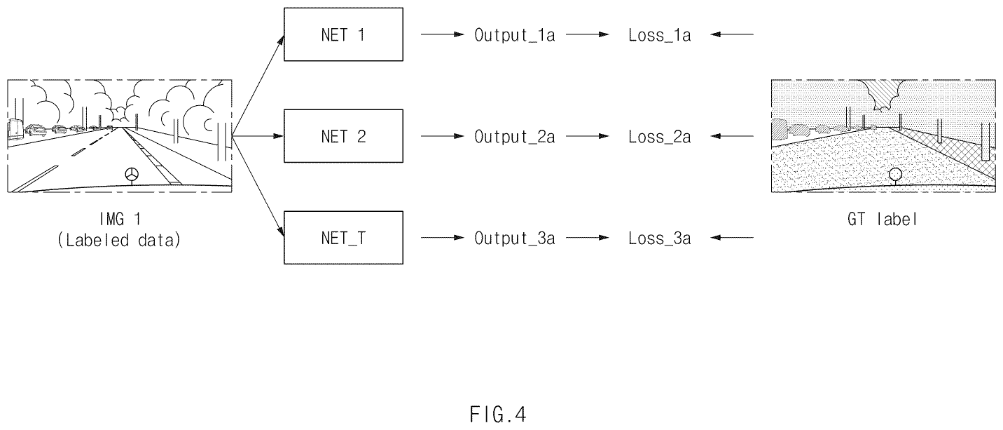

FIG. 4 is a diagram for describing supervised learning of a first network, a second network, and a target network. FIG. 4 may be a diagram for describing S310 of FIG. 3.

Referring to FIG. 4, each of a first network NET1, a second network NET2, and a target network NET_T may individually perform supervised learning.

The first network NET1 may learn a first image IMG1. The first image IMG1 may be an image with a GT label. The first network NET1 may perform learning such that a deviation Loss_1a between an output Output_1a generated by learning the first image IMG1 and the GT label is minimized. The learning of the first network NET1 may include a procedure for adjusting a first parameter of the first network NET1. The first parameter of the first network NET1 may be a variable for determining the learning process such that the output of the first network NET1 finds the GT label.

The second network NET2 may learn the first image IMG1. The second network NET2 may perform learning such that a deviation Loss_2a between an output Output_2a generated by learning the first image IMG1 and the GT label is minimized. The learning of the second network NET2 may include a procedure for adjusting a second parameter of the second network NET2. The second parameter of the second network NET2 may be a variable for determining the learning process such that the output of the second network NET2 finds the GT label.

The target network NET_T may learn the first image IMG1. The target network NET_T may perform learning such that a deviation Loss_3a between an output Output_3a generated by learning the first image IMG1 and the GT label is minimized. The learning of the target network NET_T may include a procedure for adjusting a third parameter of the target network NET_T. The third parameter of the target network NET_T may be a variable for determining the learning process such that the output of the target network NET_T finds the GT label.

The output values Output_1a, Output_2a, and Output_3a generated by the first network NET1, the second network NET2, and the target network NET_T may be one task. For example, the output values Output_1a, Output_2a, and Output_3a generated by the first network NET1, the second network NET2, and the target network NET_T may be one of 2D detection loss, 3D detection Loss, segmentation Loss, and Depth Loss shown in FIG. 1.

The supervised learning shown in FIG. 4 may proceed in a state where initial values of the first parameter of the first network NET1, the second parameter of the second network NET2, and the third parameter of the target network NET_T set differently.

As illustrated in FIG. 4, the first network NET1, the second network NET2, and the target network NET_T may learn images based on supervised learning and thus may secure the initial performance of image learning.

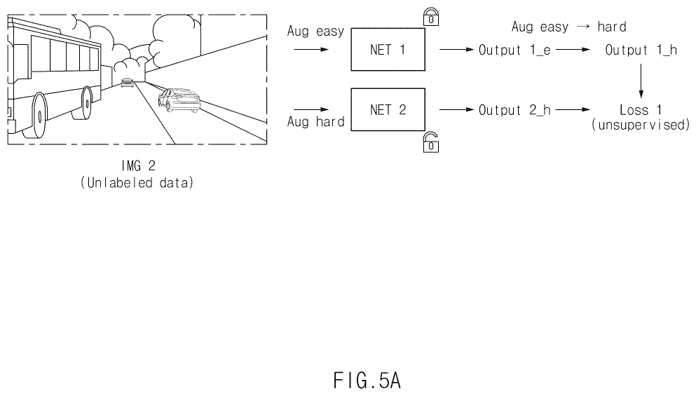

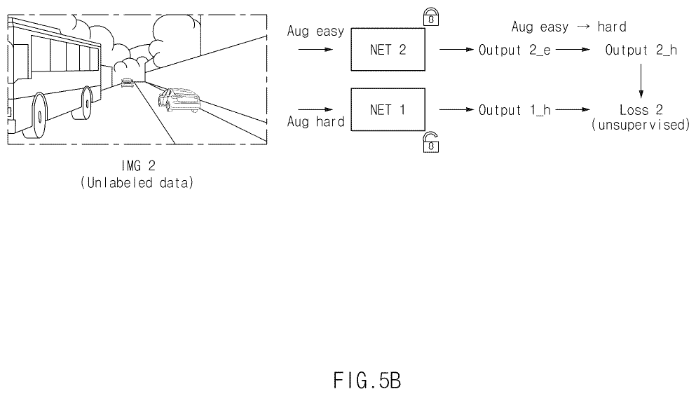

FIGS. 5A and 5B are diagrams for describing ensemble learning of a first network, a second network, and a target network. FIGS. 5A and 5B may be a diagram for describing S320 of FIG. 3. FIG. 5A is a diagram for describing a method of adjusting a second parameter of a second network. FIG. 5B is a diagram for describing a method of adjusting a first parameter of a first network.

Referring to FIGS. 5A and 5B, the first network NET1 and the second network NET2 may perform ensemble learning a second image IMG2 based on unsupervised learning. The ensemble learning of the first network NET1 and the second network NET2 may include adjusting the first parameter of the first network NET1 and adjusting a parameter of the second network NET2.

Referring to FIG. 5A, adjusting the parameters of the second network NET2 may include a procedure of preforming ensemble learning on the first network NET1 and the second network NET2 while the first parameter of the first network NET1 is fixed.

In more detail, the first network NET1 may learn the second image IMG2 to which a first augmentation technique is applied, and the first network NET1 may output a 1-1st output value Output1_e. The first augmentation technique may be a weak augmentation technique. For example, the first augmentation technique may use color jittering or flipping. The color jittering may refer to a method of changing color-related properties, such as brightness and saturation of the second image IMG2. The flipping may be flipping the second image IMG2 based on an arbitrary baseline.

The second network NET2 may learn the second image IMG2 to which a second augmentation technique is applied, and the second network NET2 may output a 2-2nd output value Output2_h. The second augmentation technique may be a different augmentation technique from the first augmentation technique and may use, for example, random rotation or random scale. The random rotation may be a method of rotating an image based on the center of the image and may be, for example, a method of rotating the image within a range of −60° to 60°. The random scale may be a method of varying the scale of the image and may be, for example, a method of adjusting the scale of the image within the range of 0.75 to 1.25.

The second network NET2 may perform learning to reduce a deviation between the 1-1st output value Output1_e and the 2-2nd output value Output2_h. In a process of determining the deviation between the 1-1st output value Output1_e and the 2-2nd output value Output2_h, the 1-1st output value Output1_e may be corrected to a first correction output value Output1_h. The first correction output value Output1_h may be obtained by applying a strong augmentation technique to the 1-1st output value Output1_e. The strong augmentation technique applied to generate the first correction output value Output1_h may be the same augmentation technique as the strong augmentation technique applied to the second image IMG2 input to the second network NET2.

The deviation between the first correction output value Output1_h and the 2-2nd output value Output2_h may determine a first loss function Loss1, and the second network NET2 may perform learning to reduce the level of the first loss function Loss1.

Referring to FIG. 5B, adjusting the parameters of the first network NET1 may include a procedure of preforming ensemble learning on the first network NET1 and the second network NET2 while the second parameter of the second network NET2 is fixed.

In more detail, the first network NET1 may learn the second image IMG2 to which the second augmentation technique is applied, and the first network NET1 may output a 1-2nd output value Output1_h.

Moreover, the second network NET2 may learn the second image IMG2 to which the first augmentation technique is applied, and the second network NET2 may output a 2-1st output value Output2_e.

The first network NET1 may perform learning to reduce a deviation between the 1-2nd output value Output1_h and the 2-1nd output value Output2_e.

In a process of determining the deviation between the 2-1st output value Output2_e and the 1-2nd output value Output1_h, the 2-1st output value Output2_e may be corrected to a second correction output value Output2_h. The second correction output value Output2_h may be obtained by applying the strong augmentation technique to the 2-1st output value Output2_e. The strong augmentation technique applied to generate the second correction output value Output2_h may be the same augmentation technique as the strong augmentation technique applied to the second image IMG2 input to the first network NET1.

The deviation between the 1-2nd output value Output1_h and the second correction output value Output2_h may determine a second loss function Loss2, and the first network NET1 may perform learning to reduce the level of the second loss function Loss2.

In the ensemble learning shown in FIGS. 5A and 5B, the 1-1st output value Output1_e and 1-2nd output value Output1_h, which are output by the first network NET1, and the 2-1st output value Output2_e and the 2-2nd output value Output2_h, which are output by the second network NET2, may be the result of learning the same task performed in S310.

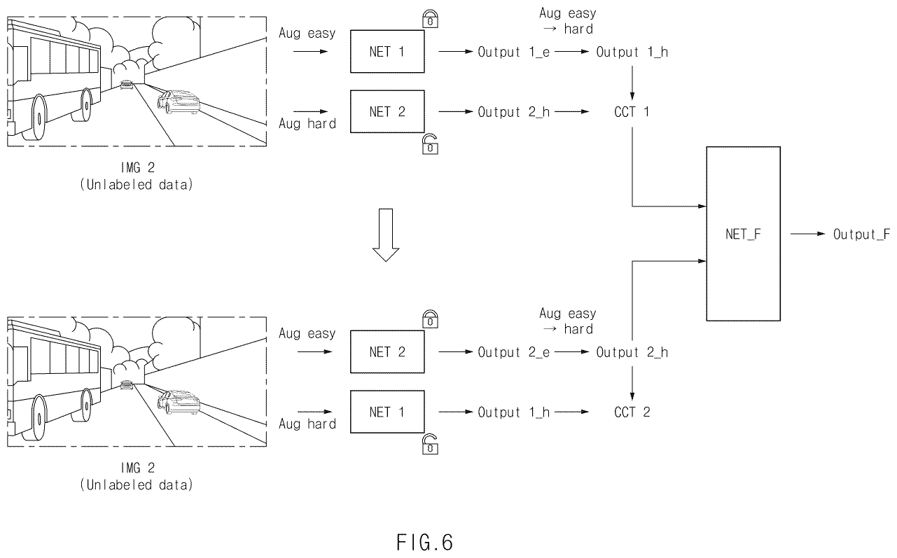

FIG. 6 is a diagram for describing a method in which a fusion network generates a fusion output. FIG. 6 may be a diagram for describing S330 of FIG. 3.

Referring to FIG. 6, a fusion network NET_F may receive a first input value CCT1 and a second input value CCT2 and then may generate a fusion output value Output_F.

The fusion network NET_F may be intended to have both an advantage of the first network NET1 and an advantage of the second network NET2. The fusion network NET_F may receive a tensor in a form [batch, 4, H, W]. Batch may denote a batch size; 4 may denote the number of channels; H may denote a height; and W may denote a width. The fusion network NET_F may generate an output value in the form of [batch, 1, H, W] based on an input tensor.

The first input value CCT1 provided to the fusion network NET_F may be obtained by concatenating the first correction output value Output1_h and the 2-2nd output value Output2_h. Besides, the second input value CCT2 may be obtained by concatenating the second correction output value Output2_h and the 1-2nd output value Output1_h. In other words, the first input value CCT1 and the second input value CCT2 may be the result obtained by performing ensemble learning on the first network NET1 and the second network NET2.

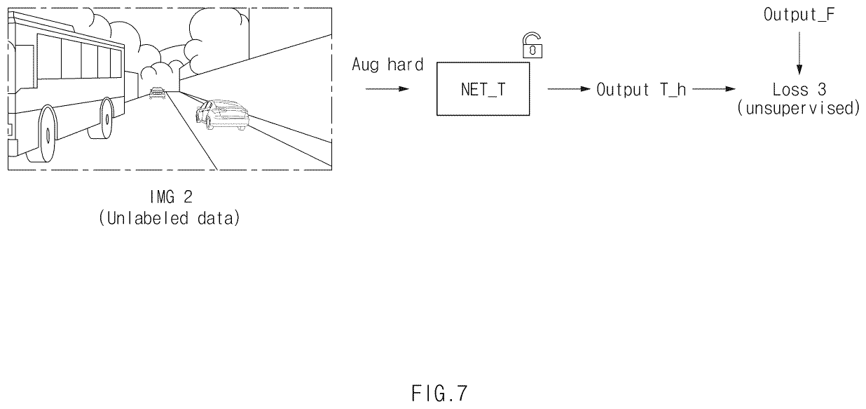

FIG. 7 is a diagram for describing a method of learning a target network based on a fusion output. FIG. 7 may be a diagram for describing S340 of FIG. 3.

Referring to FIG. 7, the target network NET_T may perform learning such that the result of learning the second image IMG2 imitates the fusion output value Output_F output by the fusion network NET_F.

In more detail, the target network NET_T may generate a third output value OutputT_h by learning the second image IMG2. The second image IMG2 may be an image without a GT label. Moreover, the target network NET_T may learn the second image IMG2 to which a second augmentation technique is applied.

The target network NET_T may determine a third loss function Loss3 based on a deviation between the third output value OutputT_h and the fusion output value Output_F output by the fusion network NET_F and may perform learning to reduce the level of the third loss function Loss3.

As a result, the target network NET_T may learn the second image IMG2 to imitate the fusion output value Output_F output by the fusion network NET_F, by applying advantages of the good recognition performance of the first network NET1 and the second network NET2.

The third output value OutputT_h output by the target network NET_T may be the result of learning the same task as that learned by the first network NET1 and the second network NET2 in S310 and S320.

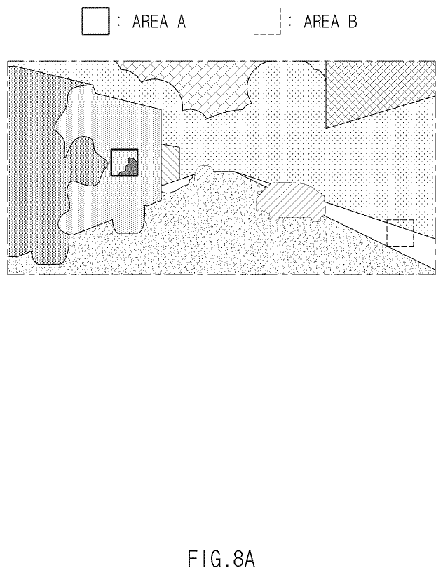

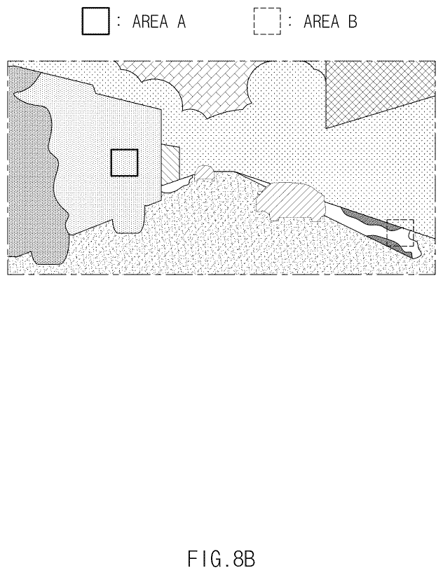

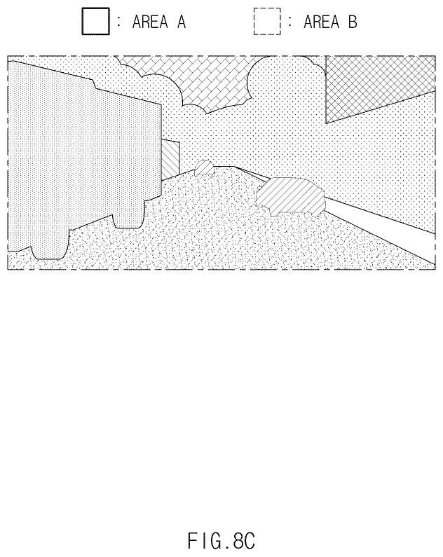

FIGS. 8A, 8B, and 8C are diagrams for describing training data generated by a target network, according to an embodiment of the present disclosure. FIGS. 8A, 8B, and 8C may be a diagram for describing training data generated by a target network performing S340 of FIG. 3.

FIG. 8A illustrates an output value obtained by the first network NET1 individually learning the second image IMG2. FIG. 8B illustrates an output value obtained by the second network NET2 individually learning the second image IMG2. FIG. 8C illustrates an output value obtained by the target network NET_T individually learning the second image IMG2. In particular, FIG. 8C may be an output value of the target network NET_T performing by learning to imitate the fusion output value through a procedure shown in FIG. 7.

As shown in FIG. 8A, the first network NET1 may not have good image recognition performance for area A but may be expected to have good recognition performance in another area.

As shown in FIG. 8B, the second network NET2 may not have good image recognition performance for area B but may be expected to have good recognition performance in another area.

On the other hand, as shown in FIG. 8C, the target network NET_T may be expected to have good recognition performance for all areas, including area A and area B. As such, the target network NET_T performing learning by using a learning method according to an embodiment of the present disclosure may generate high-level results such as GT labels even though learning the second image IMG2 without GT labels.

Accordingly, data generated by the target network NET_T performing learning by using an embodiment of the present disclosure may be used as a pseudo label with high reliability.

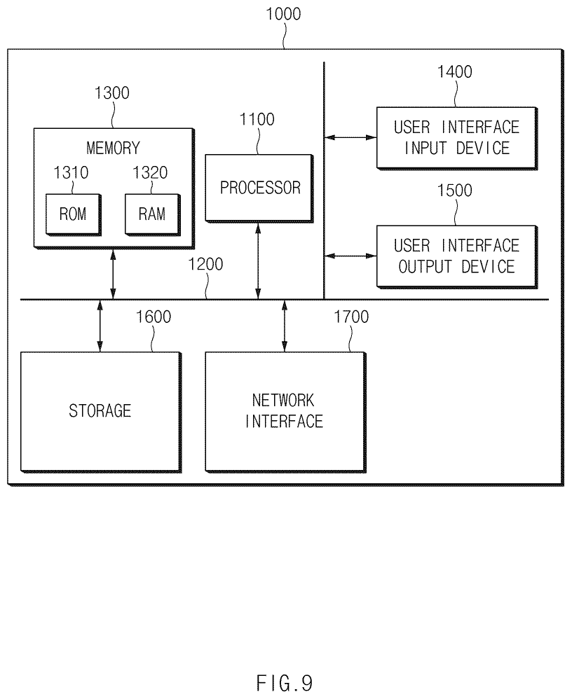

FIG. 9 illustrates a computing system according to an embodiment of the present disclosure.

Referring to FIG. 9, a computing system 1000 may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read only memory (ROM) and a random access memory (RAM).

Accordingly, the operations of the method or algorithm described in connection with the embodiments disclosed in the present disclosure may be directly implemented with a hardware module, a software module, or a combination of the hardware module and the software module, which is executed by the processor 1100. The software module may reside on a storage medium (i.e., the memory 1300 and/or the storage 1600), such as a random access memory (RAM), a flash memory, a read only memory (ROM), an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

The above description is merely an example of the technical idea of the present disclosure, and various modifications and modifications may be made by one having ordinary skill in the art without departing from the essential characteristic of the present disclosure.

Accordingly, embodiments of the present disclosure are intended not to limit but to explain the technical idea of the present disclosure, and the scope and spirit of the present disclosure is not limited by the above embodiments. The scope of protection of the present disclosure should be construed by the attached claims, and all equivalents thereof should be construed as being included within the scope of the present disclosure.

According to an embodiment of the present disclosure, the unsupervised learning performance of a target network may be improved by having advantages of two or more networks through ensemble learning-based unsupervised learning and learning the target network so as to imitate the recognition performance of networks performing ensemble learning. Moreover, pseudo label data with high similarity to the ground-truth data may be obtained by learning input data without ground-truth data by using a target network with improved recognition performance.

Furthermore, according to an embodiment of the present disclosure, because training data is generated based on the learning of the target network, a labeling task performed by humans may be omitted.

Besides, a variety of effects directly or indirectly understood through the present disclosure may be provided.

Hereinabove, although the present disclosure has been described with reference to embodiments and the accompanying drawings, the present disclosure is not limited thereto. The present disclosure may be variously modified and altered by those having ordinary skill in the art to which the present disclosure pertains without departing from the spirit and scope of the present disclosure claimed in the following claims.

What is claimed is:

1. A training data generation apparatus comprising:
a memory configured to store program instructions;
a processor configured to execute the program instructions;
a first network and a second network each configured to individually learn a first image based on supervised learning and to perform ensemble learning on a second image based on unsupervised learning;
a fusion network configured to obtain a fusion output value based on ensemble learning results of the first network and the second network; and
a target network configured to learn the second image to imitate the fusion output value.

2. The training data generation apparatus of claim 1, wherein the target network is configured to:
learn the first image based on the supervised learning and then learn the second image to imitate the fusion output value.

3. The training data generation apparatus of claim 2, wherein each of the first network, the second network, and the target network is configured to:
learn the first image based on the supervised learning in a state where initial values of a first parameter of the first network, a second parameter of the second network, and a third parameter of the target network are different from each other.

4. The training data generation apparatus of claim 1, wherein each of the first network and the second network is configured to:
adjust a second parameter of the second network by performing ensemble learning on the first network and the second network, with a first parameter fixed; and
adjust the first parameter of the first network by performing ensemble learning on the first network and the second network, with a second parameter fixed.

5. The training data generation apparatus of claim 4, wherein:
the second network is configured to adjust the second parameter to reduce a deviation between a 1-1st output value obtained by the first network learning the second image to which a first augmentation technique is applied and a 2-2nd output value obtained by the second network learning the second image to which a second augmentation technique is applied; and
the first network is configured to adjust the first parameter to reduce a deviation between a 1-2nd output value obtained by the first network learning the second image to which the second augmentation technique is applied and a 2-1st output value obtained by the second network learning the second image to which the first augmentation technique is applied.

6. The training data generation apparatus of claim 5, wherein:
the second network is configured to adjust the second parameter by using a first loss function obtained based on the 2-2nd output value and a first correction output, the first correction output obtained by augmenting the 1-1st output value with the second augmentation technique; and
the first network is configured to adjust the first parameter by using a second loss function obtained based on the 1-2nd output value and a second correction output, the second correction output obtained by augmenting the 2-1st output value with the second augmentation technique.

7. The training data generation apparatus of claim 6, wherein the fusion network is configured to:
output the fusion output value of one channel based on a first input value obtained by concatenating the first correction output and the 2-2nd output value and based on a second input value obtained by concatenating the second correction output and the 1-2 output value.

8. The training data generation apparatus of claim 7, wherein the target network is configured to:
obtain a third output value output by the target network by learning the second image; and
perform learning to reduce a level of a third loss function obtained based on the third output value and the fusion output value.

9. The training data generation apparatus of claim 1, wherein the target network is configured to:
obtain pseudo label data by learning the second image to imitate the fusion output value and then learning an image without a ground-truth label.

10. The training data generation apparatus of claim 1, wherein each of the first network, the second network, and the target network is implemented based on a multi-task learning network for obtaining output values for two or more different tasks.

11. A learning method of a target network for generating training data, the method comprising:
individually learning, by a first network, a second network, and a target network, a first image based on supervised learning;
performing, by the first network and the second network, ensemble learning on a second image;
obtaining, by a fusion network, a fusion output value based on ensemble learning results of the first network and the second network; and
learning, by the target network, the second image to imitate the fusion output value.

12. The method of claim 11, wherein performing, by the first network and the second network, the ensemble learning on the second image includes performing unsupervised learning by using the second image without ground-truth data.

13. The method of claim 11, wherein individually learning the first image based on the supervised learning includes performing learning in a state where initial values of a first parameter of the first network, a second parameter of the second network, and a third parameter of the target network are different from each other.

14. The method of claim 12, wherein performing, by the first network and the second network, the ensemble learning on the second image includes:
adjusting a second parameter of the second network by performing ensemble learning on the first network and the second network, with a first parameter fixed; and
adjusting the first parameter of the first network by performing ensemble learning on the first network and the second network, with a second parameter fixed.

15. The method of claim 14, wherein adjusting the second parameter of the second network includes:
obtaining, by the first network, a 1-1st output value by learning the second image to which a first augmentation technique is applied;
obtaining, by the second network, a 2-2nd output value by learning the second image to which a second augmentation technique is applied; and
adjusting the second parameter to reduce a deviation between the 1-1st output value and the 2-2nd output value,
wherein adjusting the first parameter of the first network includes obtaining, by the first network, a 1-2nd output value by learning the second image to which the second augmentation technique is applied,
obtaining, by the second network, a 2-1st output value by learning the second image to which the first augmentation technique is applied, and
adjusting the first parameter to reduce a deviation between the 1-2nd output value and the 2-1st output value.

16. The method of claim 15, wherein:
adjusting the second parameter includes using a first loss function obtained based on the 2-2nd output value and a first correction output, the first correction output obtained by augmenting the 1-1st output value with the second augmentation technique, and
adjusting the first parameter includes using a second loss function obtained based on the 1-2nd output value and a second correction output, the second correction output obtained by augmenting the 2-1st output value with the second augmentation technique.

17. The method of claim 16, wherein obtaining, by the fusion network, the fusion output value based on the ensemble learning results of the first network and the second network includes:
generating a first input value by concatenating the first correction output and the 2-2nd output value;
generating a second input value by concatenating the second correction output and the 1-2 output value; and
outputting, by the fusion network, the fusion output value of one channel based on the first input value and the second input value.

18. The method of claim 17, wherein learning, by the target network, the second image to imitate the fusion output value includes:
generating, by the target network, a third output value by learning the second image; and
performing, by the target network, learning to reduce a level of a third loss function obtained based on the third output value and the fusion output value.

19. The method of claim 18, wherein generating, by the target network, the third output value by learning the second image includes learning the second image to which the second augmentation technique is applied.

20. A method for generating training data, the method comprising:
individually learning, by a first network, a second network, and a target network, a first image based on supervised learning;
performing, by the first network and the second network, ensemble learning on a second image based on unsupervised learning;
obtaining, by a fusion network, a fusion output value based on ensemble learning results of the first network and the second network;
performing, by the target network, learning such that a result of learning the second image imitates the fusion output value; and
obtaining pseudo label data by learning an image without a ground-truth label based on the target network.
